(19) United States
(12) Patent Application Publication
(10) Pub. No.: US 2021/0294629 A1
(43) Pub. Date: Sep. 23, 2021

(54) INFORMATION PROCESSING SYSTEM AND NON-TRANSITORY COMPUTER READABLE MEDIUM

(71) Applicant: FUJIFILM BUSINESS INNOVATION CORP., Tokyo (JP)

(72) Inventor: Michiaki YAGI, Kanawaga (JP)

(73) Assignee: FUJIFILM BUSINESS INNOVATION CORP., Tokyo (JP)

(21) Appl. No.: 16/825,391

(22) Filed: Mar. 20, 2020

(51) Int. Cl. G06F 9/455

(52) U.S. Cl. CPC G06F 9/45558; G06F 2009/4557; G06F 2009/45595

(57) ABSTRACT

An information processing system includes multiple information processing apparatuses that process requests received from a client apparatus by using virtual machines; an accumulation unit that accumulates a process request processable in any one of the multiple information processing apparatuses among the process requests received by the multiple information processing apparatuses; a registration unit that registers each information processing apparatus as to whether the information processing apparatus is an unverified information processing apparatus or a verified information processing apparatus; and a controller. The process request is accumulated together with information indicating one of the multiple information processing apparatuses that is associated with the process request.

### CROSS-REFERENCE TO RELATED APPLICATIONS

This application is based on and claims priority under 35 USC 119 from Japanese Patent Application No. 2019-134319 filed Jul. 22, 2019.

### BACKGROUND

### (i) Technical Field

The present disclosure relates to an information processing system and a non-transitory computer readable medium.

### (ii) Related Art

Japanese Unexamined Patent Application Publication No. 2018-072948 discloses an information processing system including multiple information processing apparatuses. The information processing system includes a first holding unit, a second holding unit, and a processing unit. The first holding unit holds information regarding a request for performing data processing for each of data processing types. The second holding unit holds information regarding a request for performing data processing for testing. The data processing unit is provided with a normal mode and a test mode. In the normal mode, the execution request information held in the first holding unit is acquired and the data processing is performed. In the test mode, execution request information held in the second holding unit is acquired and the data processing is performed. The data processing unit starts up in the test mode, and the test mode transitions to the normal mode in response to an instruction from a user.

### SUMMARY

Aspects of non-limiting embodiments of the present disclosure relate to an information processing system and a non-transitory computer readable medium that are enabled to perform a blue-green deployment in which after one of multiple information processing apparatuses is updated and verified, a live information processing apparatus is swapped with the verified information processing apparatus, the blue-green deployment being performed in a case where the multiple information processing apparatuses are to process respective process requests and even in a configuration in which a process request processable in any of the multiple information processing apparatuses is accumulated in one accumulation unit and is thereafter processed in one of the information processing apparatuses.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

### Information Processing System

According to an aspect of the present disclosure, there is provided an information processing system including multiple information processing apparatuses, an accumulation unit, and a registration unit. The multiple information processing apparatuses process process requests received from a client apparatus. The process requests are processed by using virtual machines. The accumulation unit accumulates a process request processable in any one of the multiple information processing apparatuses among the process requests received by the multiple information processing apparatuses. The process request is accumulated together with information indicating one of the multiple information processing apparatuses that is associated with the process request. The registration unit registers each information processing apparatus as to whether the information processing apparatus is an unverified information processing apparatus or a verified information processing apparatus. The information processing apparatus includes a controller that performs control by which if the information processing apparatus is registered as a verified information processing apparatus in the registration unit, a process request associated with the verified information processing apparatus among the process requests accumulated in the accumulation unit is acquired and processed, and if the information processing apparatus is registered as an unverified information processing apparatus in the registration unit, a process request associated with the information processing apparatus among the process requests accumulated in the accumulation unit is acquired and processed.

### BRIEF DESCRIPTION OF THE DRAWINGS

Exemplary embodiments of the present disclosure will be described in detail based on the following figures, wherein:

FIG. 1 is a diagram illustrating the system configuration of an information processing system in an exemplary embodiment of the present disclosure;

FIG. 2 is a block diagram illustrating the hardware configuration of each of service providing apparatuses in the exemplary embodiment of the present disclosure;

FIG. 3 is a block diagram illustrating the functional configuration of an information processing system including some of the service providing apparatuses;

FIGS. 4A to 4C are each a diagram for explaining a specific swap method in a blue-green deployment;

FIG. 5 is a diagram for explaining a state where an unverified service providing apparatus is simply operated in a system in such a configuration as illustrated in FIG. 3;

FIG. 6 is a diagram illustrating the system configuration of an information processing system in an exemplary embodiment of the present disclosure that has a verification-status management unit;

FIG. 7 is a diagram illustrating the functional configuration of the information processing system of the exemplary embodiment of the present disclosure that has the verification-status management unit;

FIG. 8 is a table illustrating a relationship of each service providing apparatus with an apparatus ID;

FIG. 9 is an example table illustrating a verification-status management table managed by the verification-status management unit;

FIG. 10 is a table illustrating a specific example in a case of accumulating public process requests in a public-process-request accumulation unit;

FIG. 11 is a flowchart for explaining the operation of the information processing system of the exemplary embodiment of the present disclosure;

FIG. 12 is a diagram illustrating the configuration of an information processing system of an exemplary embodiment of the present disclosure that includes an autoscaling switching controller;

FIG. 13 is a diagram for explaining the detailed configuration of the autoscaling switching controller illustrated in FIG. 12; and

FIG. 14 is an example table illustrating apparatus information stored in an apparatus-information storage unit.

### DETAILED DESCRIPTION

Exemplary embodiments of the present disclosure will be described in detail with reference to the drawings.

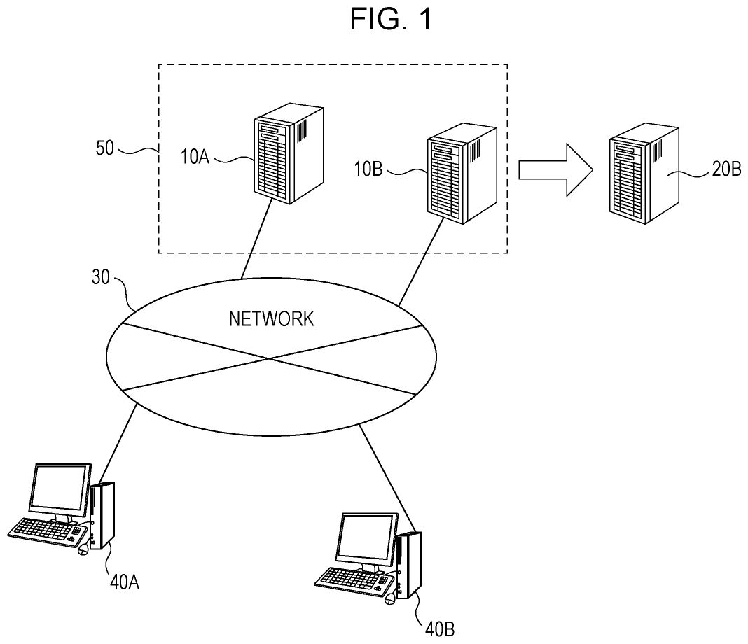

FIG. 1 is a diagram illustrating the system configuration of an information processing system of an exemplary embodiment of the present disclosure.

As illustrated in FIG. 1, an information processing system 50 of the exemplary embodiment of the present disclosure includes service providing apparatuses 10A and 10B that are connected to each other and to terminal apparatuses 40A and 40B functioning as client terminals via a network 30 such as the Internet.

The service providing apparatus 10A is an information processing apparatus for Company A that provides users in Company A with services. The service providing apparatus 10B is an information processing apparatus for Company B that provides users in Company B with services.

As the services provided by the service providing apparatuses 10A and 10B, there are services by which various processes are executed, such as an optical character reading (OCR) process, a translation process, a storing process, a cost adjustment process, and an image conversion process. The service providing apparatuses 10A and 10B are also capable of executing the various processes in cooperation with another service providing apparatus, instead of providing the services standalone.

Each user in Company A accesses the service providing apparatus 10A by using the terminal apparatus 40A that is a client apparatus and utilizes the services provided by Company A. Each user in Company B accesses the service providing apparatus 10B by using the terminal apparatus 40B and utilizes the services provided by Company B.

Generally, in a case where the service providing apparatuses as described above undergo system upgrading, software change, or the like, for example, whether trouble is to occur after starting the services needs to be verified before starting the services.

Note that the service providing apparatuses 10A and 10B currently providing the services have undergone such a verification and have started providing the services after the verification of no occurrence of trouble. That is, the live service providing apparatuses 10A and 10B are verified information processing apparatuses.

Hereinafter, a case where a service providing apparatus 20B for Company B for which the verification is not completed is swapped with the verified service providing apparatus 10B for Company B will be described.

The following description assumes that the service providing apparatus 10B has undergone system upgrading, software change, or the like and that the service providing apparatus 20B is in an unverified status where the verification of no trouble occurrence in actual operation has not been completed.

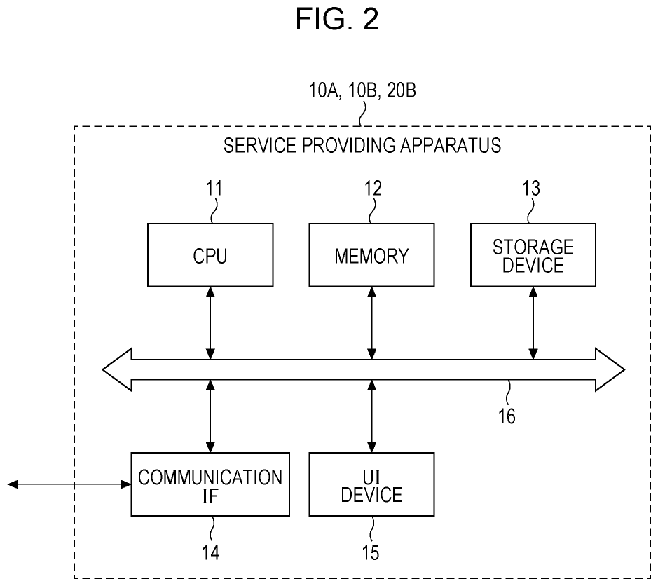

FIG. 2 illustrates the hardware configuration of the above-described service providing apparatuses 10A, 10B, and 20B.

As illustrated in FIG. 2, the service providing apparatuses 10A, 10B, and 20B each include a central processing unit (CPU) 11, a memory 12, a storage device 13 such as a hard disk drive (HDD), a communication interface (IF) 14 that transmits and receives data to and from an external apparatus via the network 30, and a user interface (UI) device 15 including a keyboard and any of a touch panel and a liquid crystal display. These components are connected to each other via a control bus 16.

The CPU 11 executes predetermined processes in accordance with a control program stored in the memory 12 or the storage device 13 and controls the operation of the service providing apparatuses 10A, 10B, and 20B. Note that this exemplary embodiment is described on the assumption that the CPU 11 reads out and runs the control program stored in the memory 12 or the storage device 13; however, the program may be provided to the CPU 11 in such a manner as to be stored in a storage medium such as a compact disc read-only memory (CD-ROM).

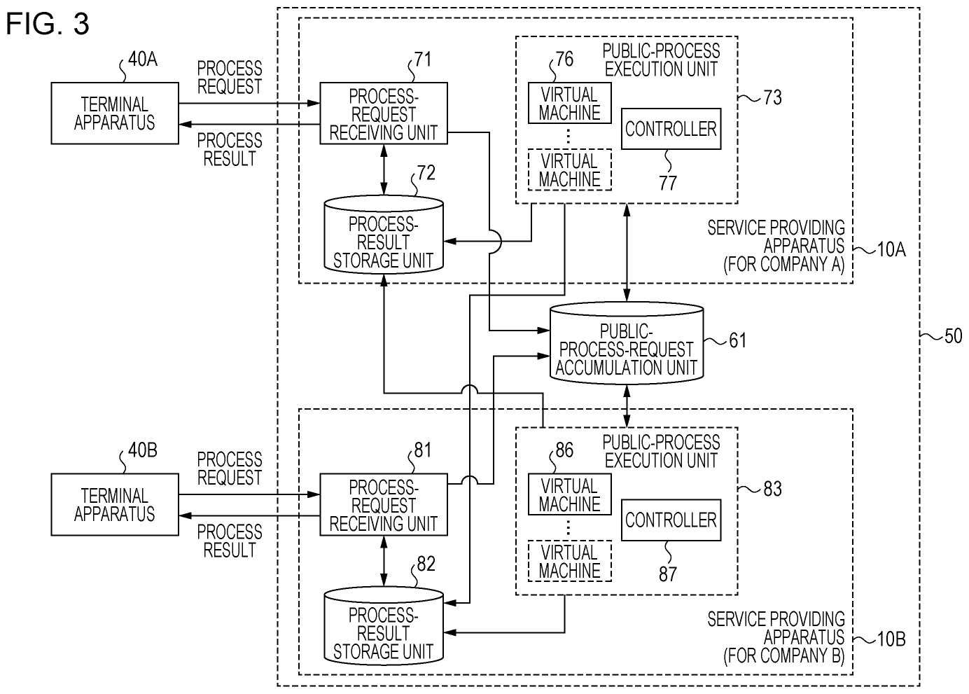

FIG. 3 is a block diagram illustrating the functional configuration of the information processing system including the service providing apparatuses 10A and 10B implemented by running the above-described control program. FIG. 3 illustrates an example configuration in a case of implementations using the two verified service providing apparatuses 10A and 10B but does not illustrate the configuration of the service providing apparatus 20B; however, the service providing apparatus 20B has the same functional configuration as that of the service providing apparatuses 10A and 10B.

As illustrated in FIG. 3, the information processing system 50 in this exemplary embodiment includes the service providing apparatus 10A for Company A, the service providing apparatus 10B for Company B, and a public-process-request accumulation unit 61.

The service providing apparatus 10A for Company A performs an operation for executing a process on the basis of a process request received from the terminal apparatus 40A and transmitting a process result as a reply to the terminal apparatus 40A. The service providing apparatus 10B for Company B performs an operation for executing a process on the basis of a process request received from the terminal apparatus 40B and transmitting the process result as a reply to the terminal apparatus 40B.

The service providing apparatus 10A also includes a process-request receiving unit 71, a process-result storage unit 72, and a public-process execution unit 73.

Likewise, the service providing apparatus 10B includes a process-request receiving unit 81, a process-result storage unit 82, and a public-process execution unit 83.

The public-process execution unit 73 includes multiple virtual machines 76 and a controller 77 that controls the number of activated virtual machines 76 and the overall operation of the public-process execution unit 73. Likewise, the public-process execution unit 83 includes multiple virtual machines 86 and a controller 87 that controls the number of activated virtual machines 86 and the overall operation of the public-process execution unit 83.

The term “virtual machine” denotes a computer configured virtually or in a pseudo manner in one physical computer. The use of such virtual machine technology enables multiple virtual machines to be configured in a physical machine such as a server or an apparatus configured by one computer and to perform parallel processing. Note that the virtual machines are also referred to as an instance in some cases.

A process for controlling the number of activated virtual machines on the basis of the workload of a process to be executed is referred to as autoscaling. Performing autoscaling leads to scale out that is such control that increases the number of activated virtual machines at the time of high workload of the process to be executed and scale in that is such control that decreases the number of activated virtual machines at the time of low workload of the process to be executed.

As described above, the service providing apparatus 10A is an information processing apparatus that processes a process request by using the activated virtual machines, the process request being received from the terminal apparatus 40A that is a client apparatus. The service providing apparatus 10B is an information processing apparatus that processes a process request by using the activated virtual machines, the process request being received from the terminal apparatus 40B that is a client apparatus.

The service providing apparatuses 10A and 10B are configured to be able to configure virtual machines that execute different processes in the respective apparatuses and virtual machines that execute a process common to the two apparatuses.

Hereinafter, a process request processable in any of the two service providing apparatuses 10A and 10B is referred to as a public process request, and a process request processable in only one of the two service providing apparatuses 10A and 10B is referred to as a local process request. Regarding the two service providing apparatuses 10A and 10B, a virtual machine allowed to process a public process request is referred to as a public virtual machine, and a virtual machine allowed to process a local process request is referred to as a local virtual machine. However, for simpler explanation, only a configuration in processing a public process request by using a public virtual machine will be described with reference to FIG. 3.

Among process requests respectively received by the two service providing apparatuses 10A and 10B, the public-process-request accumulation unit 61 accumulates, in a queue, a process request processable in any of the two service providing apparatuses 10A and 10B.

The functional configuration of each of the service providing apparatuses 10A and 10B will be described.

First, the structure of the service providing apparatus 10A will be described.

The process-request receiving unit 71 receives a process request from the terminal apparatus 40A and accumulates the received process request in the queue in the public-process-request accumulation unit 61. The process-request receiving unit 71 acquires the process result of the received process request from the process-result storage unit 72 and transmits the process result as a reply to the terminal apparatus 40A.

The process-result storage unit 72 stores therein the process result obtained by executing the process in the request by the public-process execution unit 73. If the process in the request received by the service providing apparatus 10A is executed by the public-process execution unit 83 of the service providing apparatus 10B, the process-result storage unit 72 receives the result of the process from the public-process execution unit 83 and stores the process result therein.

The public-process execution unit 73 is configured to be able to activate the multiple virtual machines 76. The controller 77 controls the number of activated virtual machines 76, and the activated virtual machines 76 execute processes in the respective public process requests accumulated in the public-process-request accumulation unit 61.

The public-process execution unit 73 stores the result of each process in the corresponding public process request received by the service providing apparatus 10A in the process-result storage unit 72 of the service providing apparatus 10A and transfers the result of each process in the corresponding public process request received by the service providing apparatus 10B to the process-result storage unit 82 of the service providing apparatus 10B.

The process-request receiving unit 81, the process-result storage unit 82, and the public-process execution unit 83 of the service providing apparatus 10B perform the same operations as those by the process-request receiving unit 71, the process-result storage unit 72, and the public-process execution unit 73 of the service providing apparatus 10A, and the detailed description thereof is not provided.

In the information processing system 50 of this exemplary embodiment, the configuration as described above sometimes causes a process request received by the service providing apparatus 10A from the terminal apparatus 40A to be executed by the public-process execution unit 83 of the service providing apparatus 10B and a process request received by the service providing apparatus 10B from the terminal apparatus 40B to be executed by the public-process execution unit 73 of the service providing apparatus 10A.

A case where the live service providing apparatus 10B is swapped with the unverified service providing apparatus 20B in implementations performed in the configuration as described above will be described.

In the case where the service providing apparatus 10B is swapped with the service providing apparatus 20B without stopping the service provision to Company B, a swap method called a blue-green deployment is used.

The blue-green deployment is a swap method in which after one of multiple information processing apparatuses is updated and verified, a live information processing apparatus is swapped with a verified information processing apparatus. The blue-green deployment enables the live information processing apparatus to be swapped with the verified information processing apparatus without stopping the provided services.

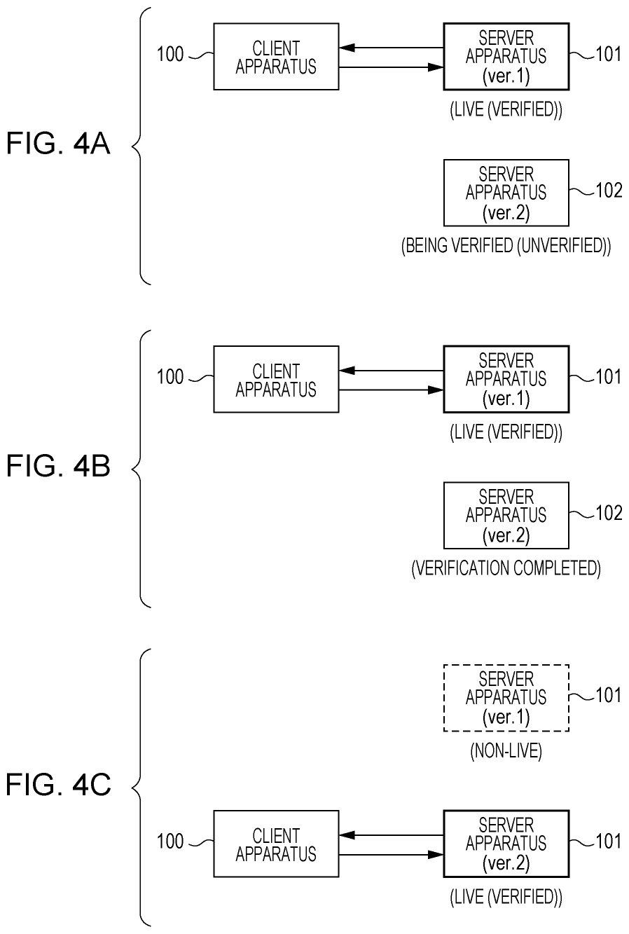

A specific swap method for the blue-green deployment as described above will be described with reference to FIG. 4.

A system example illustrated in FIG. 4A to 4C has a configuration as to be described below. A client apparatus 100 transmits a process request to a server apparatus 101, and the server apparatus 101 executes the process in the process request and transmits the process result as a reply to the client apparatus 100.

In the system configuration as described above, the live server apparatus 101 currently providing a service to the client apparatus 100 is a verified apparatus that proves no trouble occurrence by the verification as described above.

A case where the server apparatus 101 is operated by software of version 1 as illustrated in FIG. 4A and the version of the software is updated with version 2 will be described. In such a case, immediately updating the version of the software of the server apparatus 101 with version 2 may cause some trouble. Accordingly, as illustrated in FIG. 4A, a server apparatus 102 having the same hardware configuration as that of the server apparatus 101 and having software of version 2 installed thereon is prepared. The server apparatus 102 has not been verified naturally and thus is in an unverified status.

Subsequently, as illustrated in FIG. 4B, in the state where the server apparatus 101 provides services, whether software of version 2 has no trouble is verified in such a manner that the server apparatus 102 is operated and caused to execute various processes by using a different client apparatus. The description herein assumes that the verification of the server apparatus 102 is completed without any trouble.

Accordingly, as illustrated in FIG. 4C, the server apparatus 101 is swapped with the server apparatus 102. The server apparatus 102 is thereby in a live state, and the server apparatus 101 is in a non-live state.

Swapping as described above causes the software of a server apparatus without stopping the service provision to the client apparatus 100.

If the swap method using the blue-green deployment as described above is simply applied to the case where the verified service providing apparatus 10B is swapped with the unverified service providing apparatus 20B in the system in the configuration as illustrated in FIG. 3, trouble occurs.

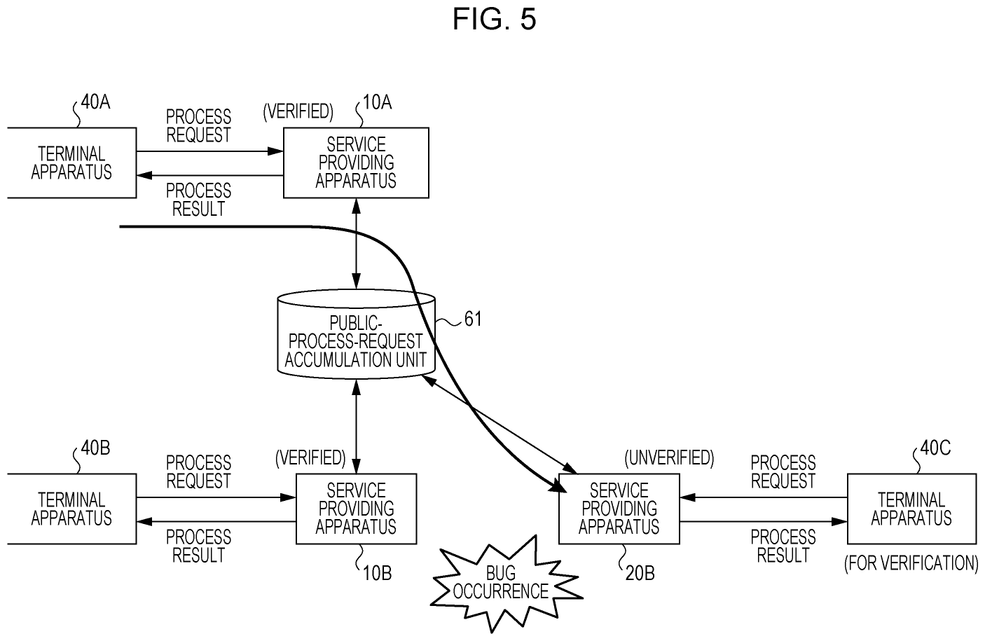

Specifically, a state where the unverified service providing apparatus 20B is simply operated in the configuration of the system as illustrated in FIG. 3 will be described with reference to FIG. 5.

FIG. 5 has a configuration in which the unverified service providing apparatus 20B is added to the configuration in which the verified service providing apparatuses 10A and 10B are operated and provide services to the terminal apparatuses 40A and 40B.

A terminal apparatus 40C is an apparatus for verifying the service providing apparatus 20B. The terminal apparatus 40C performs the verification in such a manner as to transmit, to the service providing apparatus 20B, a process request for verifying that the operation of software to be updated or the like has no trouble and thereafter to verify the process result.

In the information processing system of this exemplary embodiment, a public process request processable in any service providing apparatus is accumulated once in the public-process-request accumulation unit 61 and is then processed by a service providing apparatus allowed to execute the process in the request.

Accordingly, there is a possibility of a case where after a process request transmitted, for example, from the terminal apparatus 40A to the service providing apparatus 10A is accumulated in the public-process-request accumulation unit 61, the unverified service providing apparatus 20B processes the process request. If the software or the like of the service providing apparatus 20B has any bug, trouble occurs in executing the process request transmitted from the terminal apparatus 40A, and thus a correct process result is not obtained.

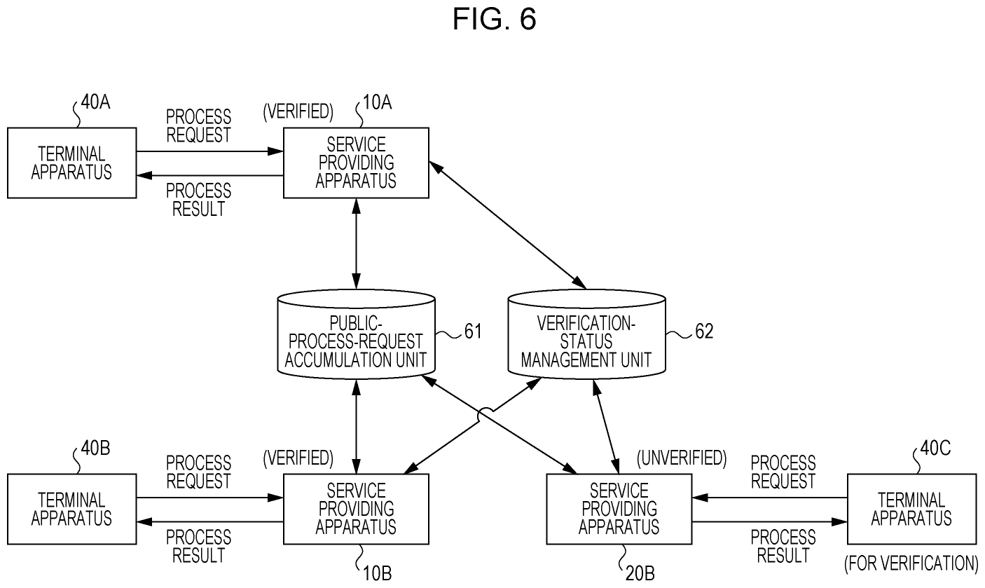

Hence, the information processing system of this exemplary embodiment is provided with a verification-status management unit 62 as illustrated in FIG. 6.

The verification-status management unit 62 functions as a registration unit that registers each of the service providing apparatuses 10A, 10B, and 20B that are the multiple information processing apparatuses as to whether the service providing apparatus 10A, 10B, or 20B itself is an unverified apparatus or a verified apparatus.

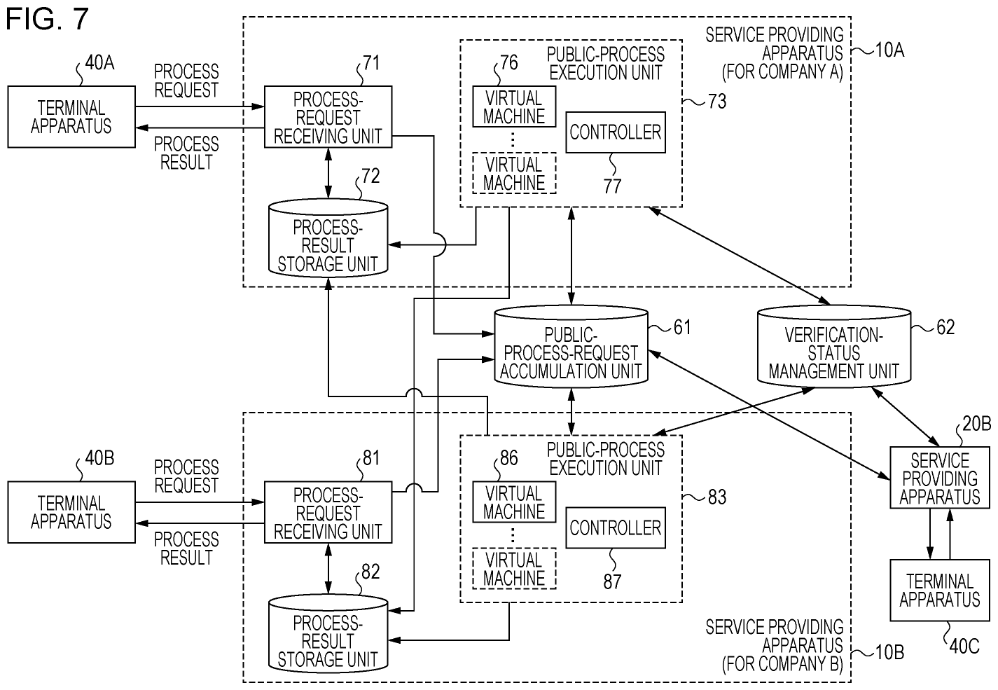

FIG. 7 illustrates the functional configuration of the information processing system of this exemplary embodiment that has the verification-status management unit 62.

The functional configuration of the service providing apparatus 20B is not illustrated in FIG. 7 but has the same functional configuration as that of the service providing apparatuses 10A and 10B. Further, for simpler explanation, in FIG. 7, lines representing the storing of process results in the public-process execution units 73 and 83 by the process-result storage unit of the service providing apparatus 20B and lines representing the storing of process results in the process-result storage units 72 and 82 of the respective service providing apparatuses 10A and 10B by the public-process execution unit of the service providing apparatus 20B are omitted.

A verification-status management table representing the verification statuses of the respective service providing apparatuses 10A, 10B, and 20B registered in the verification-status management unit 62 will be described.

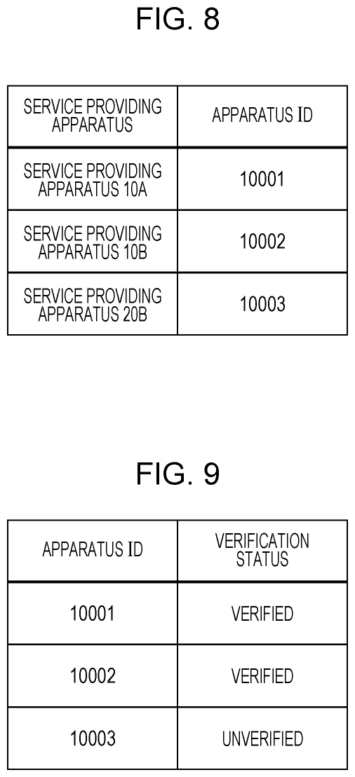

First, the description for this exemplary embodiment assumes that each of the service providing apparatuses 10A, 10B, and 20B is associated with an apparatus ID as illustrated in FIG. 8. Specifically, the service providing apparatuses 10A, 10B, and 20B are respectively associated with “10001”, “10002”, and “10003” as apparatus IDs.

FIG. 9 illustrates an example of the verification-status management table managed by the verification-status management unit 62. In the verification-status management table illustrated in FIG. 9, each service providing apparatus is identified by using an apparatuses ID, and the apparatus ID is associated with the verification status of the service providing apparatus with the apparatus ID. In this case, the service providing apparatuses 10A and 10B are registered as a verified apparatus, and the service providing apparatus 20B is registered as an unverified apparatus.

The term “unverified” denotes a state where the verification has not been completed, and an unverified status includes a state where the verification is being performed and a state before the verification is performed.

The term “verified” denotes a state where the verification has been completed and proves no trouble. A verified status includes a live state and a non-live state.

Note that the term “live” denotes a state where service providing in which a process request is received from a client terminal apparatus and thereafter the process is executed is being performed. Specifically, the live state of an apparatus denotes a state where the apparatus has been verified. However, even a verified apparatus may be in the non-live state in which the apparatus is not in operation at present.

Among process requests respectively received by the three service providing apparatuses 10A, 10B, and 20B, the public-process-request accumulation unit 61 accumulates, in the queue, a process request processable in any of the three service providing apparatuses 10A, 10B, and 20B together with information indicating one of the three service providing apparatuses 10A, 10B, and 20B that is associated with the process request.

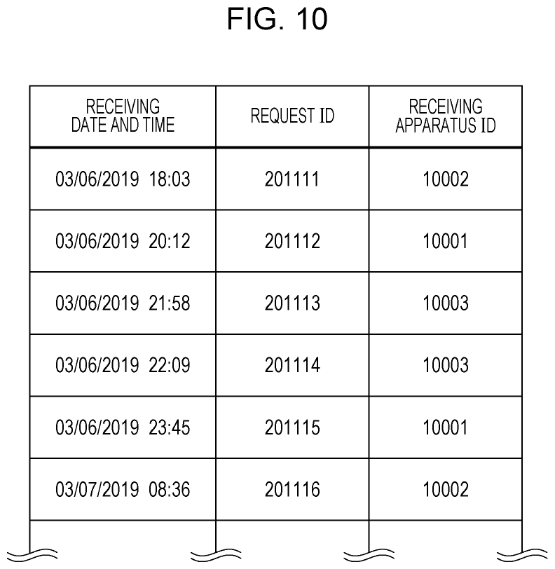

FIG. 10 illustrates a specific example in a case of accumulating public process requests in the public-process-request accumulation unit 61.

As illustrated in FIG. 10, the public-process-request accumulation unit 61 stores a receiving date and time when a public process request is received from the terminal apparatus 40A, 40B, or 40C, a request ID for identifying the public process request, and a receiving apparatus ID for identifying a service providing apparatus that receives the public process request.

It is understood that, for example, the public process request having the request ID “201111” is received by the service providing apparatus 10B having the apparatus ID “10002” at 18:03 on Mar. 6, 2019.

Each of the controllers 77 and 87 of the service providing apparatuses 10A and 10B and the controller of the service providing apparatus 20B performs the following control. If the service providing apparatus 10A, 10B, or 20B thereof is registered as a verified apparatus in the verification-status management unit 62, a process request associated with a verified service providing apparatus among process requests accumulated in the public-process-request accumulation unit 61 is acquired and processed. If the service providing apparatus 10A, 10B, or 20B is registered as an unverified apparatus in the verification-status management unit 62, a process request associated with the service providing apparatus 10A, 10B, or 20B among the process requests accumulated in the public-process-request accumulation unit 61 is acquired and processed.

According to the control as described above, a process request transmitted from the terminal apparatus 40A or 40B is processed by one of the service providing apparatuses 10A and 10B, and a process request transmitted from the terminal apparatus 40C is processed by the service providing apparatus 20B. That is, the process requests transmitted from the terminal apparatuses 40A and 40B are prevented from being processed by the unverified service providing apparatus 20B.

In addition, each of the controllers 77 and 87 of the service providing apparatuses 10A and 10B and the controller of the service providing apparatus 20B performs the following control. If the service providing apparatus 10A, 10B, or 20B thereof is registered as a verified apparatus in the verification-status management unit 62, the number of activated public virtual machines in the service providing apparatus 10A, 10B, or 20B is controlled in accordance with the state of a process request associated with the verified service providing apparatus among the process requests accumulated in the public-process-request accumulation unit 61. If the service providing apparatus 10A, 10B, or 20B is registered as an unverified apparatus in the verification-status management unit 62, the number of activated public virtual machines in the service providing apparatus 10A, 10B, or 20B is controlled in accordance with the state of a process request associated with the service providing apparatus 10A, 10B, or 20B among the process requests accumulated in the public-process-request accumulation unit 61.

Specifically, the controllers 77 and 87 of the respective service providing apparatuses 10A and 10B execute autoscaling. In autoscaling, the number of activated public virtual machines in the service providing apparatus 10A, 10B, or 20B is increased or decreased in accordance with the state of a public process request received by one of the service providing apparatuses 10A and 10B among the public process requests accumulated in the public-process-request accumulation unit 61. In the control by the service providing apparatus 20B, autoscaling is executed in accordance with the state of the public process request received by the service providing apparatus 20B among the public process requests accumulated in the public-process-request accumulation unit 61.

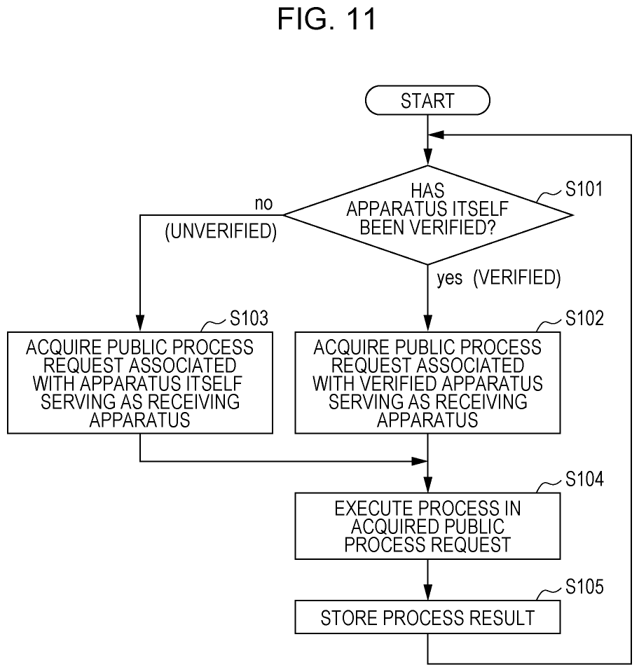

The operation of the information processing system of this exemplary embodiment will be described with reference to a flowchart in FIG. 11.

In step S101, each of the controllers 77 and 87 of the respective service providing apparatuses 10A and 10B and the controller of the service providing apparatus 20B refers to the verification-status management unit 62 and judges whether the service providing apparatus 10A, 10B, or 20B thereof is a verified apparatus or an unverified apparatus.

If the service providing apparatus 10A, 10B, or 20B is judged to be a verified apparatus in step S101, the controller thereof acquires, in step S102, a public process request associated with a verified apparatus serving as a receiving apparatus among the public process requests accumulated in the public-process-request accumulation unit 61.

If the service providing apparatus 10A, 10B, or 20B is judged to be an unverified apparatus in step S101, the controller thereof acquires, in step S103, a public process request associated with the service providing apparatus 10A, 10B, or 20B serving as a receiving apparatus among the public process requests accumulated in the public-process-request accumulation unit 61.

The controller executes the process in the acquired public process request in step S104 and stores the process result in a predetermined result storage unit in step S105.

Note that the public-process execution units of the respective service providing apparatuses 10A, 10B, and 20B of this exemplary embodiment each executes autoscaling for controlling the number of activated virtual machines.

If each of the public-process execution units 73 and 83 of the respective service providing apparatuses 10A and 10B independently activates the corresponding ones of the virtual machines 76 and 86 and executes processes in accordance with the state of a public process request received by one of the service providing apparatuses 10A and 10B, there is a possibility that more virtual machines than needed are activated.

Accordingly, in the information processing system of this exemplary embodiment, an autoscaling switching controller 63 for selecting a service providing apparatus that activates a public virtual machine and processes the public process request may be provided.

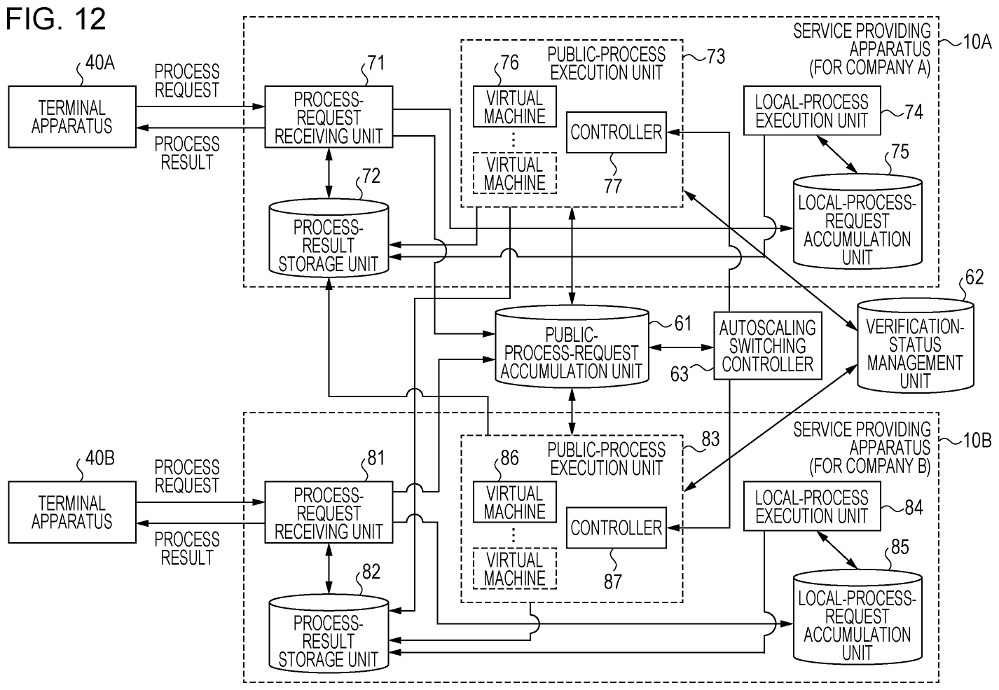

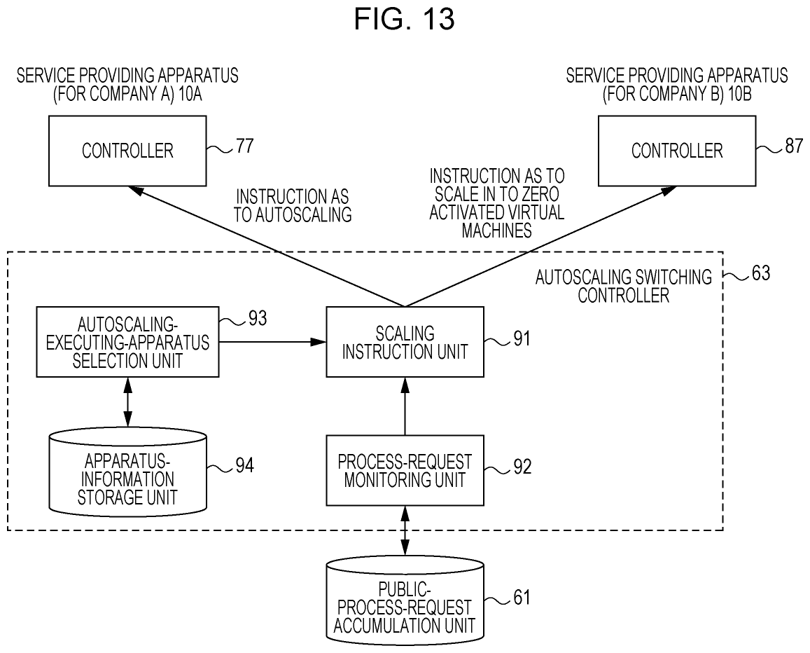

FIG. 12 illustrates the configuration of the information processing system of this exemplary embodiment that includes the autoscaling switching controller 63. In FIG. 12, for simpler explanation, the service providing apparatus 20B and the terminal apparatus 40C are omitted.

In addition, FIG. 12 illustrates a case of providing not only the autoscaling switching controller 63 but also a configuration for executing a process in a local process request by the service providing apparatuses 10A and 10B, compared with the functional block diagram illustrated in FIG. 7.

Specifically, the service providing apparatus 10A is provided with a local-process execution unit 74 and a local-process-request accumulation unit 75, and the service providing apparatus 10B is provided with a local-process execution unit 84 and a local-process-request accumulation unit 85.

The autoscaling switching controller 63 controls the number of activated public virtual machines in each of the two service providing apparatuses 10A and 10B in accordance with the state of a process request accumulated in the public-process-request accumulation unit 61.

For example, the autoscaling switching controller 63 controls the number of activated public virtual machines on the basis of the amount of at least one process request accumulated in the public-process-request accumulation unit 61, accumulation time that is a period of time from the start of the accumulation to the current time, and the like.

The autoscaling switching controller 63 selects a verified service providing apparatus among the multiple service providing apparatuses and instructs the controller of the selected service providing apparatus to acquire a process request associated with the verified service providing apparatus among the process requests accumulated in the public-process-request accumulation unit 61.

With reference to the information in the verification-status management unit 62, the service providing apparatuses 10A and 10B are herein verified service providing apparatuses. Accordingly, when controlling the number of activated public virtual machines in the service providing apparatuses 10A and 10B, the autoscaling switching controller 63 selects one of the two service providing apparatuses 10A and 10B and controls the number of activated public virtual machines in the selected service providing apparatus 10A or 10B.

Specifically, the autoscaling switching controller 63 instructs the controller of the other one of the two service providing apparatuses 10A and 10B that is not selected to set a fixed value, for example, zero as the number of activated public virtual machines in the not selected service providing apparatus 10A or 10B.

In the configuration illustrated in FIG. 12, the controller 77 executes autoscaling for controlling the number of activated virtual machines 76 under the control of the autoscaling switching controller 63.

The local-process execution unit 74 is configured to be able to activate multiple virtual machines like the public-process execution unit 73. The controller thereof (not illustrated) controls the number of activated virtual machines, and the activated virtual machines execute processes in local process requests accumulated in the local-process-request accumulation unit 75.

The local-process-request accumulation unit 75 accumulates, in the queue, a local process request processable only in the service providing apparatus 10A among the process requests received by the process-request receiving unit 71.

The local-process execution unit 84 and the local-process-request accumulation unit 85 of the service providing apparatus 10B respectively perform the same operations as those by the local-process execution unit 74 and the local-process-request accumulation unit 75 of the service providing apparatus 10A, and thus detailed description thereof is not provided.

The process-result storage unit 72 stores therein not only a process result from the public-process execution unit 73 but also a process result obtained by executing the local process request by the local-process execution unit 74.

The detailed configuration of the autoscaling switching controller 63 illustrated in FIG. 12 will be described with reference to FIG. 13.

As illustrated in FIG. 13, the autoscaling switching controller 63 includes a scaling instruction unit 91, a process-request monitoring unit 92, an autoscaling-executing-apparatus selection unit 93, and an apparatus-information storage unit 94.

The process-request monitoring unit 92, for example, regularly monitors public process requests accumulated in the public-process-request accumulation unit 61 and transmits the monitoring result to the scaling instruction unit 91.

The scaling instruction unit 91 judges whether autoscaling needs to be executed on the basis of the result of the monitoring by the process-request monitoring unit 92. If the scaling instruction unit 91 judges that autoscaling needs to be executed, the scaling instruction unit 91 instructs the controller 77 of the service providing apparatus 10A or the controller 87 of the service providing apparatus 10B to execute autoscaling.

At this time, the scaling instruction unit 91 instructs only one of the service providing apparatuses 10A and 10B that is selected by the autoscaling-executing-apparatus selection unit 93 to execute autoscaling. The scaling instruction unit 91 does not instruct the other one of the service providing apparatuses 10A and 10B that is not selected to execute autoscaling or instructs the not selected service providing apparatus 10A or 10B to scale in the number of activated virtual machines to zero.

FIG. 13 illustrates a case where the scaling instruction unit 91 selects the service providing apparatus 10A as an autoscaling target and instructs the controller 77 to execute autoscaling and instructs the controller 87 to scale in the number of activated virtual machines to zero.

The autoscaling-executing-apparatus selection unit 93 selects one of the service providing apparatuses 10A and 10B as the autoscaling target by using the apparatus information stored in the apparatus-information storage unit 94, that is, pieces of attribute information regarding the two respective service providing apparatuses 10A and 10B.

The apparatus-information storage unit 94 stores, as pieces of apparatus information, pieces of attribute information such as the number of activated public virtual machines at present in each of the service providing apparatuses 10A and 10B, a creation date and time for each of the service providing apparatuses 10A and 10B, and the processing record of a process in the public process request executed by each of the service providing apparatuses 10A and 10B.

For example, the autoscaling-executing-apparatus selection unit 93 may also select, as an autoscaling target apparatus, the service providing apparatus having the largest number of activated public virtual machines at present by referring to the apparatus information in the apparatus-information storage unit 94.

Alternatively, the autoscaling-executing-apparatus selection unit 93 may select, as an autoscaling target apparatus, one of the service providing apparatuses 10A and 10B that has the earliest creation date and time by referring to the apparatus information in the apparatus-information storage unit 94.

Further, the autoscaling-executing-apparatus selection unit 93 may select, as an autoscaling target apparatus, one of the service providing apparatuses 10A and 10B that has processed a received process request by referring to the apparatus information in the apparatus-information storage unit 94.

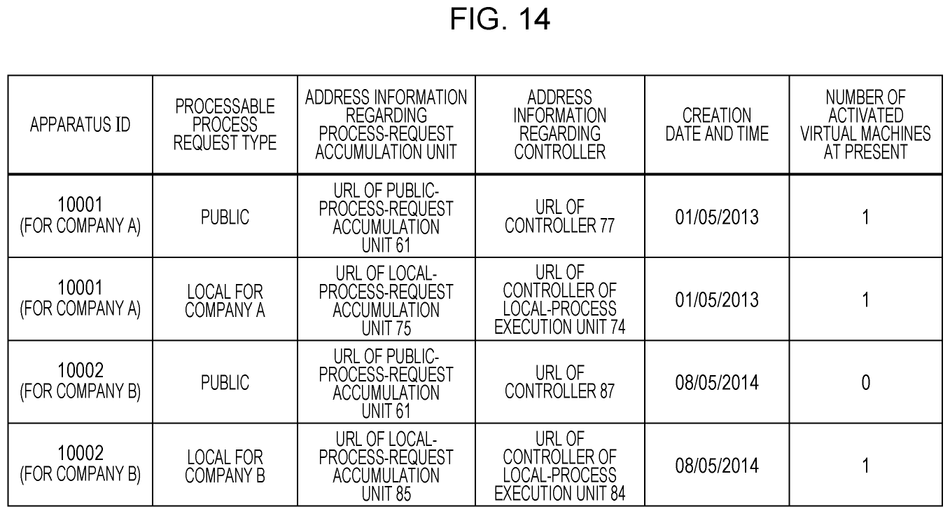

FIG. 14 illustrates an example of the apparatus information as described above stored in the apparatus-information storage unit 94.

As illustrated in FIG. 14, the apparatus-information storage unit 94 stores, in a table, pieces of information such as an apparatus ID, a processable process request type, address information regarding a process-request accumulation unit, address information regarding a controller for autoscaling, a creation date and time, and the number of activated virtual machines at present.

The autoscaling-executing-apparatus selection unit 93 is enabled to select an autoscaling target apparatus after acquiring information such as the creation date and time for each of the service providing apparatuses 10A and 10B and the number of activated public virtual machines at present by referring to the apparatus information.

### Modification

The exemplary embodiments have heretofore been described by using the case where the present disclosure is applied to a service providing apparatus that executes a process in a process request received from a client apparatus and transmits a process result as a reply to the client apparatus; however, the present disclosure is not limited to these exemplary embodiments. The present disclosure is likewise applicable to any information processing apparatus that processes a process request received from a client apparatus by using a virtual machine.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. An information processing system comprising:
a plurality of information processing apparatuses that process process requests received from a client apparatus, the process requests being processed by using virtual machines;
an accumulation unit that accumulates a process request processable in any one of the plurality of information processing apparatuses among the process requests received by the plurality of information processing apparatuses, the process request being accumulated together with information indicating one of the plurality of information processing apparatuses that is associated with the process request; and
a registration unit that registers each information processing apparatus as to whether the information processing apparatus is an unverified information processing apparatus or a verified information processing apparatus,
the information processing apparatus including a controller that performs control by which if the information processing apparatus is registered as a verified information processing apparatus in the registration unit, a process request associated with the verified information processing apparatus among the process requests accumulated in the accumulation unit is acquired and processed, and if the information processing apparatus is registered as an unverified information processing apparatus in the registration unit, a process request associated with the information processing apparatus among the process requests accumulated in the accumulation unit is acquired and processed.

2. The information processing system according to claim 1,
wherein if the information processing apparatus is registered as a verified information processing apparatus in the registration unit, the controller performs control of the number of activated public virtual machines publicly present in any one of the plurality of information processing apparatuses among the virtual machines in the information processing apparatus in accordance with a state of a process request associated with the verified information processing apparatus among the process requests accumulated in the accumulation unit, and if the information processing apparatus is registered as an unverified information processing apparatus in the registration unit, the controller performs control of the number of activated public virtual machines publicly present in any one of the plurality of information processing apparatuses among the virtual machines in the information processing apparatus in accordance with a state of a process request associated with the information processing apparatus among the process requests accumulated in the accumulation unit.

3. The information processing system according to claim 1, further comprising:
an instruction unit that selects one of verified information processing apparatuses among the plurality of information processing apparatuses and that instructs a controller of the selected information processing apparatus to acquire a process request associated with a verified information processing apparatus among the process requests accumulated in the accumulation unit and to process the process request.

4. The information processing system according to claim 3,
wherein the instruction unit instructs a controller of one of the verified information processing apparatuses that is not selected among the plurality of information processing apparatuses to set zero as the number of activated public virtual machines in the not selected verified information processing apparatus.

5. The information processing system according to claim 3,
wherein the instruction unit selects the verified information processing apparatus among the plurality of information processing apparatuses by using pieces of attribute information regarding the respective verified information processing apparatuses.

6. The information processing system according to claim 4,
wherein the instruction unit selects the verified information processing apparatus among the plurality of information processing apparatuses by using pieces of attribute information regarding the respective verified information processing apparatuses.

7. The information processing system according to claim 5,
wherein each piece of attribute information is the number of activated public virtual machines at present, and wherein the instruction unit selects a verified information processing apparatus having a largest number of activated public virtual machines at present.

8. The information processing system according to claim 6,
wherein each piece of attribute information is the number of activated public virtual machines at present, and
wherein the instruction unit selects a verified information processing apparatus having a largest number of activated public virtual machines at present.

9. The information processing system according to claim 5,
wherein each piece of attribute information is a creation date and time for a corresponding one of the information processing apparatuses, and
wherein the instruction unit selects a verified information processing apparatus having an earliest creation date and time among the plurality of information processing apparatuses.

10. The information processing system according to claim 6,
wherein each piece of attribute information is a creation date and time for a corresponding one of the information processing apparatuses, and
wherein the instruction unit selects a verified information processing apparatus having an earliest creation date and time among the plurality of information processing apparatuses.

11. The information processing system according to claim 5,
wherein each piece of attribute information is a processing record of a process request, and
wherein the instruction unit selects a verified information processing apparatus having processed a received process request.

12. The information processing system according to claim 6,
wherein each piece of attribute information is a processing record of a process request, and
wherein the instruction unit selects a verified information processing apparatus having processed a received process request.

13. A non-transitory computer readable medium storing a program causing a computer to execute a process comprising:
processing process requests in a plurality of information processing apparatuses by using virtual machines, the process requests being received from a client apparatus;
accumulating a process request processable in any one of the plurality of information processing apparatuses among the process requests received in the plurality of information processing apparatuses, the process request being accumulated together with information indicating one of the plurality of information processing apparatuses that is associated with the process request;
registering each information processing apparatus as to whether the information processing apparatus is an unverified information processing apparatus or a verified information processing apparatus; and
performing control by which if the information processing apparatus is registered as a verified information processing apparatus in the registering, a process request associated with the verified information processing apparatus among the process requests accumulated in the accumulating is acquired and processed, and if the information processing apparatus is registered as an unverified information processing apparatus in the registering, a process request associated with the information processing apparatus among the process requests accumulated in the accumulating is acquired and processed.

14. An information processing system comprising:
a plurality of information processing apparatuses that process process requests received from a client apparatus, the process requests being processed by using virtual machines;
accumulation means for accumulating a process request processable in any one of the plurality of information processing apparatuses among the process requests received by the plurality of information processing apparatuses, the process request being accumulated together with information indicating one of the plurality of information processing apparatuses that is associated with the process request; and
registration means for registering each information processing apparatus as to whether the information processing apparatus is an unverified information processing apparatus or a verified information processing apparatus,
the information processing apparatus including a control means for performing control by which if the information processing apparatus is registered as a verified information processing apparatus in the registration means, a process request associated with the verified information processing apparatus among the process requests accumulated in the accumulation means is acquired and processed, and if the information processing apparatus is registered as an unverified information processing apparatus in the registration means, a process request associated with the information processing apparatus among the process requests accumulated in the accumulation means is acquired and processed.
